(19) United States
(12) Patent Application Publication
(10) Pub. No.: US 2012/0284332 A1
(43) Pub. Date: Nov. 8, 2012

(54) SYSTEMS AND METHODS FOR FORMATTING A PRESENTATION IN WEBPAGE BASED ON NEURO-RESPONSE DATA

(76) Inventors: Anantha Pradeep, Berkeley, CA (US); Ramachandran Gurumoorthy, Berkeley, CA (US); Robert T. Knight, Berkeley, CA (US)

(21) Appl. No.: 13/288,504

(22) Filed: Nov. 3, 2011

Related U.S. Application Data
(60) Provisional application No. 61/409,876, filed on Nov. 3, 2010.

(51) Int. Cl. G06F 15/16

(52) U.S. Cl. 709/204

(57) ABSTRACT

Example methods, systems and tangible machine readable instructions to format a presentation in a social network are disclosed. An example method includes collecting first neuro-response data from the user while the user is engaged with a social network. The example method also includes formatting the presentation based on the first neuro-response data and social network information identifying a characteristic of the social network of the user.

### RELATED APPLICATION

This patent claims the benefit of U.S. Provisional Patent Application Ser. No. 61/409,876, entitled “Effective Data Presentation in Social Networks,” which was filed on Nov. 3, 2010, and which is incorporated herein by reference in its entirety.

### FIELD OF THE DISCLOSURE

This disclosure relates generally to internetworking, and, more particularly, to systems and methods for formatting a presentation in a webpage based on neuro-response data.

### BACKGROUND

Traditional systems and methods for formatting presentations that are displayed on websites such as social network site are often standardized for all users of the network. Personalized presentations such as targeted advertisements are created and presented by companies that have limited knowledge of the intended recipients.

### BRIEF DESCRIPTION OF THE DRAWINGS

FIG. 1 is a schematic illustration of an example system constructed in accordance with the teachings of this disclosure to format a presentation on a webpage based on neuro-response data.

FIG. 2 shows an example user profile and network information table for use with the system of FIG. 1.

FIG. 3 is a flow chart representative of example machine readable instructions that may be executed to implement the example system of FIG. 1.

FIG. 4 illustrates an example processor platform that may execute the instructions of FIG. 3 to implement any or all of the example methods, systems and/or apparatus disclosed herein.

### DETAILED DESCRIPTION

Example systems and methods to format a presentation on webpage based on neuro-response data are disclosed. Example presentations include advertisements, entertainment, learning materials, factual materials, instructional materials, problem sets and/or any other materials that may be displayed to a user interacting with a webpage such as a webpage of a social network such as, for example, Facebook, Google+, Myspace, Yelp, LinkedIn, Friendster, Flickr, Twitter, Spotify, Bebo, Renren, Weibo, any other online network, and/or any non-web-based network. The materials for the presentation may be materials from one or more of the user's connections in the network, a parent, a coach, a tutor, an instructor, a teacher, a professor, a librarian, an educational foundation, a test administrator, etc. In examples disclosed herein, the materials are formatted based on historical neuro-response data of the user collected while the user interacts with a social network to make the presentation likely to obtain the attention of the user.

Example systems and methods disclosed herein identify user information and social network information associated with the user. In some examples, an example presentation is formatted based on user profile information and/or network information. User profile information may include, for example, a user neurological response, a user physiological response, a psychological profile, stated preferences, user activity, previously known effective formats for the user and/or a user's location. Network information may include, for example, information related to a user's network including the number and complexity of connections, available format types, a type of presentation and/or previously known effective formats for the presentation. An effectiveness of a presentation format may also be determined based on a user's neurological and/or physiological response data collected while or after the user is exposed to the presentation.

There are many formats that may be used to present materials to a user in a manner that the user would find interesting and engaging. For example, traditional learning materials are presented to a user in a static manner. However, using the example methods and systems disclosed herein, learning materials may be presented to the user via a game on a social network, in a banner, via a wall post, via a chat message, etc. In addition, the materials presented may be formatted based on the user's education level, learning style, learning preferences, prior course work, class information, academic standing and/or response including, for example, providing more time when a user is struggling or making one or more mistakes. The presentation of materials may also be formatted based on how a user is currently interacting with the presentation, how the user discusses the presentation with other people in the network, and/or how the user comments on the presentation. For example, a user comment to a connection in the network that a particular presentation was boring may prompt a change in the format of the presentation to make the presentation more appealing including, for example, different color, font, size, sound, animation, personalization, duration or content. In some examples, if the user activity indicates that the user previously or typically is highly active on the social network, the presentation may be changed more frequently to provide additional and/or alternative content to the user.

In some examples, formatting of the presentation includes dynamically modifying the visual or audio characteristics of the presentation and/or an operating characteristic of a user device that is used to observe the presentation via a display. Example displayed include, for example, headsets, goggles, projection systems, speakers, tactile surfaces, cathode ray tubes, televisions, computer monitors, and/or any other suitable display device for presenting presentation. The dynamic modification, in some examples, is a result of changes in a measured user neuro-response reflecting attention, alertness, and/or engagement that are detected and/or a change in a user's location. In some such examples, user profiles are maintained, aggregated and/or analyzed to identify characteristics of user devices and presentation formats that are most effective for groups, subgroups, and/or individuals with particular neurological and/or physiological states or patterns. In some such examples, users are monitored using any desired biometric sensor. For example, users may be monitored using electroencephalography (EEG) (e.g., a via headset containing electrodes), cameras, infrared sensors, interaction speed detectors, touch sensors and/or any other suitable sensor. In some examples disclosed herein, configurations, fonts, content, organization and/or any other characteristic of a presentation are dynamically modified based on changes in one or more user(s)' state(s). For example, biometric, neurological and/or physiological data including, for example, data collected via eye-tracking, galvanic skin response (GSR), electromyography (EMG), EEG and/or other biometric, neurological and/or physiological data collection techniques, may be used to assess an alertness of a user as the user interacts with the presentation or the social network through which the presentation is displayed. In some examples, the biometric, neurological and/or physiological data is measured, for example, using a camera device associated with the user device and/or a tactile sensor such as a touch pad on a device such as a computer, a phone (e.g., a smart phone) and/or a tablet (e.g., an iPad®).

Based on a user's profile, the measured biometric data, the measured neurological data, the measured physiological data and/or the network information (i.e., data, statistics, metrics and other information related to the network), one or more aspects of an example presentation are modified. In some examples, based on a user's current state as reflected in the neuro-response data (e.g., the user's alertness level and/or changes therein), other data in the user's profile and/or the network information, a font size and/or a font color, a scroll speed, an interface layout (for example showing and/or hiding one or more menus) and/or a zoom level of one or more items are changed automatically. Also, in some examples, based on an assessment of the user's current state, of the user's profile (and/or changes therein) and/or of the network information, the presentation is automatically changed to highlight information (e.g., contextual information, links, etc.) and/or additional activities based on the area of engagement as reflected in the user's neuro-response data.

Based on information about a user's current neuro-response data, changes or trends in the current user neuro-response data, and/or a user's neuro-response data history as reflected in the user's profile, some example presentations are changed to automatically highlight semantic and/or image elements. In some examples, less or more items (e.g. a different number of element(s) or group(s) of element(s)) are chosen based on a user's profile, a user's current state, and/or the network information. In some examples, presentation characteristics, such as placement of menus, to facilitate fluent processing are chosen based on a user's neuro-response data, data in the user's profile and/or network information. An example profile may include a history of a user's neurological and/or physiological states over time. Such a profile may provide a basis for assessing a user's current mental state relative to a user's baseline mental state. In some such examples, the profile includes user preferences (e.g., affirmations such as stated preferences and/or observed preferences).

Aggregated usage data of an individual and/or group(s) of individuals are employed in some examples to identify patterns of neuro-response data and/or to correlate patterns of presentation attributes or characteristics. In some examples, test data from individual and/or group assessments (which may be either presentation specific and/or presentation independent), are compiled to develop a repository of user and/or group neuro-response data and preferences. In some examples, neurological and/or physiological assessments of effectiveness of a presentation characteristic are calculated and/or extracted by, for example, spectral analysis of neurological and/or physiological responses, coherence analysis, inter-frequency coupling mechanisms, Bayesian inference, granger causality methods and/or other suitable analysis techniques. Such effectiveness assessments may be maintained in a repository or database and/or implemented in a presentation for in-use assessments (e.g., real time assessment of the effectiveness of a presentation characteristic while a user is concurrently observing and/or interacting with the presentation).

Examples disclosed herein evaluate neurological and/or physiological measurements representative of, for example, alertness, engagement and/or attention and adapt one or more aspects of a presentation based on the measurement(s). Examples disclosed herein are applicable to any type(s) of presentation including, for example, presentations that appear on smart phone(s), mobile device(s), tablet(s), computer(s) and/or other machine(s). Some examples employ sensors such as, for example, cameras, detectors and/or monitors to collect one or more measurements such as pupillary dilation, body temperature, typing speed, grip strength, EEG measurements, eye movements, GSR data and/or other neurological, physiological and/or biometric data. In some such examples, if the neurological, physiological and/or biometric data indicates that a user is very attentive, some example presentations are modified to include more detail. Any number and/or type(s) of presentation adjustments may be made based on neuro-response data.

An example method of formatting a presentation includes compiling a user profile for a user of the social network based on first neuro-response data collected from the user while the user is engaged with the social network. The example method also includes formatting the presentation based on the user profile and information about the social network.

Some example methods of formatting a presentation disclosed herein include collecting neuro-response data from a user while the user is engaged with a social network. The example method also includes formatting the presentation based on the neuro-response data and social network information identifying a characteristic of the social network of the user.

In some examples, formatting the presentation is based on a known effective formatting parameter. Also, in some examples, the user profile is based on second neuro-response data (e.g., current user state data) collected from the user while the user is exposed to the presentation. In such examples, the method also includes determining an effectiveness of the formatting of the presentation based on the second neuro-response data and re-formatting the presentation if, based on the second neuro-response data, the presentation is not effective.

In some examples, formatting the presentation is based additionally or alternatively on user activity. In such examples, the user activity is one or more of how the user comments (e.g., posts on the social network), how the user interacts with connections in the social network, and/or an attention level. Also, in some examples, formatting the presentation is based on a geographic location of user.

In some examples, the presentation is one or more of learning material, an advertisement, and/or entertainment. In some examples, the presentation appears in one or more of a game, a banner on a webpage, a pop-up display, a newsfeed, a chat message, a website, and/or an intermediate display, for example, while other content is loading.

In some examples, the neuro-response data includes data representative of an interaction between a first frequency band of activity of a brain of the user and a second frequency band different than the first frequency band.

In some examples, the formatting of the presentation includes determining one or more of a presentation type, a length of presentation, an amount of content presented in a session, a presentation medium (e.g., an audio format, a video format, etc.) and/or an amount of content presented simultaneously.

In some examples, the social network information includes a number of connections of the user in the social network and/or a complexity of the connections.

An example system to format a presentation disclosed herein includes a data collector to collect first neuro-response data from a user while the user is engaged with a social network. The example system also includes a profiler to compile a user profile for the user based on the first neuro-response data. In addition, the example system includes a selector to format the presentation based on the user profile and information associated with the social network such as, for example, information identifying a characteristic of the social network.

In some examples, the selector formats the presentation based on a known effective formatting parameter. In some examples, the selector formats the presentation based on a current user state developed from second neuro-response data and/or based on user activity including one or more of a user comment posted on the social network, and/or how the user interacts with connections in the network. Also, in some examples, the selector determines one or more of a presentation type, a length of presentation, an amount of content presented in a session and/or an amount of content presented simultaneously.

Also, in some examples, the data collector collects second neuro-response data from the user while the user is exposed to the presentation. In some examples, the profiler updates the user profile with the second neuro-response data. In addition, some example systems include an analyzer to determine an effectiveness of the presentation format based on the second neuro-response data, and/or a selector to re-format the presentation based on the second neuro-response data if the presentation is not effective.

In some examples, the system includes a location detector to determine a location of the user, the selector to format the presentation based on the location.

Example tangible machine readable medium storing instructions thereon which, when executed, cause a machine to at least format a presentation are disclosed. In some examples, the instructions cause the machine to compile a user profile for a user of a social network based on first neuro-response data collected from the user while the user is engaged with the social network. In some examples, the instructions cause the machine to format the presentation based on the user profile, a current user state, and/or information about the social network including, for example, information reflecting activity in the social network.

In some examples, the instructions cause the machine to update the user profile based on second neuro-response data collected from the user while exposed to and/or after exposure to the presentation, to determine an effectiveness of the formatting of the presentation based on the second neuro-response data, and/or re-format the presentation based on the second neuro-response data if the presentation is not effective

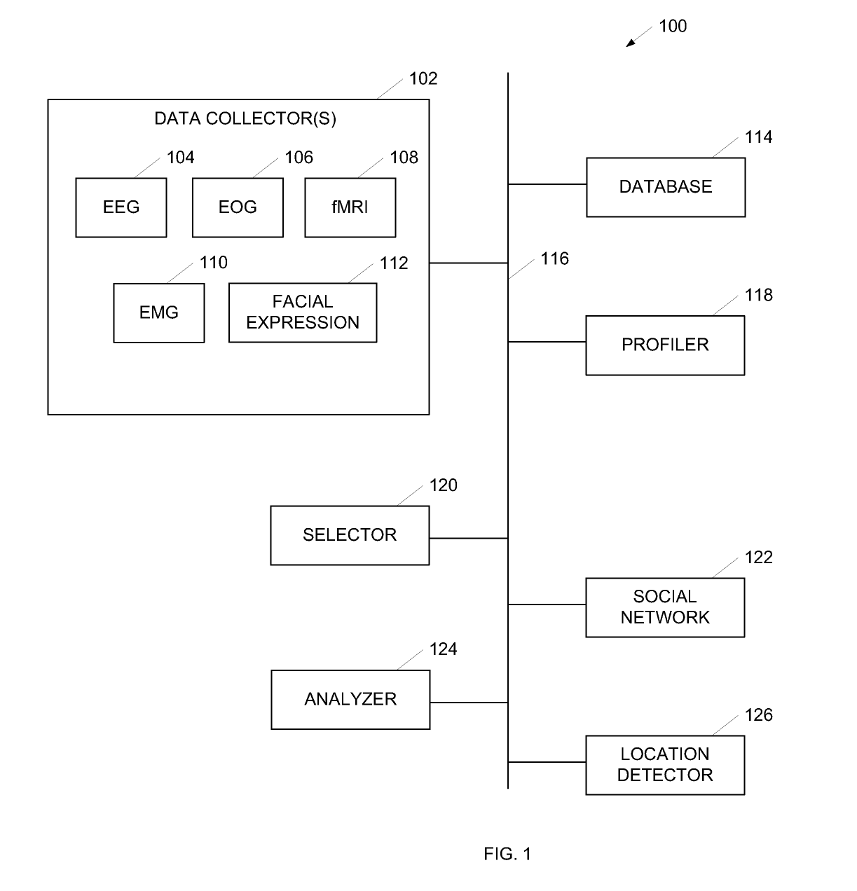

FIG. 1 illustrates an example system 100 that may be used to format a presentation. The example system 100 of FIG. 1 includes one or more data collector(s) 102 to obtain neuro-response data from the user while or after the user is exposed to a presentation. The example data collector(s) 102 may include, for example, one or more electrode(s), camera(s) and/or other sensor(s) to gather any type of biometric, neurological and/or physiological data, including, for example, functional magnetic resonance (fMRI) data, electroencephalography (EEG) data, magnetoencephalography (MEG) data and/or optical imaging data. The data collector(s) 102 may gather data continuously, periodically or aperiodically.

The data collector(s) 102 of the illustrated example gather biometric, neurological and/or physiological measurements such as, for example, central nervous system measurements, autonomic nervous system measurement and/or effector measurements, which may be used to evaluate a user's reaction(s) and/or impression(s) of the presentation and/or other stimulus. Some examples of central nervous system measurement mechanisms that are employed in some examples include fMRI, EEG, MEG and optical imaging. Optical imaging may be used to measure the absorption or scattering of light related to concentration of chemicals in the brain or neurons associated with neuronal firing. MEG measures magnetic fields produced by electrical activity in the brain. fMRI measures blood oxygenation in the brain that correlates with increased neural activity.

EEG measures electrical activity resulting from thousands of simultaneous neural processes associated with different portions of the brain. EEG also measures electrical activity associated with post synaptic currents occurring in the milliseconds range. Subcranial EEG can measure electrical activity with high accuracy. Although bone and dermal layers of a human head tend to weaken transmission of a wide range of frequencies, surface EEG provides a wealth of useful electrophysiological information. In addition, portable EEG with dry electrodes also provides a large amount of useful neuro-response information.

EEG data can be obtained in various frequency bands. Brainwave frequencies include delta, theta, alpha, beta, and gamma frequency ranges. Delta waves are classified as those less than 4 Hz and are prominent during deep sleep. Theta waves have frequencies between 3.5 to 7.5 Hz and are associated with memories, attention, emotions, and sensations. Theta waves are typically prominent during states of internal focus. Alpha frequencies reside between 7.5 and 13 Hz and typically peak around 10 Hz. Alpha waves are prominent during states of relaxation. Beta waves have a frequency range between 14 and 30 Hz. Beta waves are prominent during states of motor control, long range synchronization between brain areas, analytical problem solving, judgment, and decision making. Gamma waves occur between 30 and 60 Hz and are involved in binding of different populations of neurons together into a network for the purpose of carrying out a certain cognitive or motor function, as well as in attention and memory. Because the skull and dermal layers attenuate waves above 75-80 Hz, brain waves above this range may be difficult to detect. Nonetheless, in some of the disclosed examples, high gamma band (kappa-band: above 60 Hz) measurements are analyzed, in addition to theta, alpha, beta, and low gamma band measurements to determine a user's reaction(s) and/or impression(s) (such as, for example, attention, emotional engagement and memory). In some examples, high gamma waves (kappa-band) above 80 Hz (detectable with sub-cranial EEG and/or MEG) are used in inverse model-based enhancement of the frequency responses indicative of a user's reaction(s) and/or impression(s). Also, in some examples, user and task specific signature sub-bands (i.e., a subset of the frequencies in a particular band) in the theta, alpha, beta, gamma and/or kappa bands are identified to estimate a user's reaction(s) and/or impression(s). Particular sub-bands within each frequency range have particular prominence during certain activities. In some examples, multiple sub-bands within the different bands are selected while remaining frequencies are blocked via band pass filtering. In some examples, multiple sub-band responses are enhanced, while the remaining frequency responses may be attenuated.

Interactions between frequency bands are demonstrative of specific brain functions. For example, a brain processes the communication signals that it can detect. A higher frequency band may drown out or obscure a lower frequency band. Likewise, a high amplitude may drown out a band with low amplitude. Constructive and destructive interference may also obscure bands based on their phase relationship. In some examples, the neuro-response data may capture activity in different frequency bands and determine that a first band may be out of a phase with a second band to enable both bands to be detected. Such out of phase waves in two different frequency bands are indicative of a particular communication, action, emotion, thought, etc. In some examples, one frequency band is active while another frequency band is inactive, which enables the brain to detect the active band. A circumstance in which one band is active and a second, different band is inactive is indicative of a particular communication, action, emotion, thought, etc. For example, neuro-response data showing increasing theta band activity occurring simultaneously with decreasing alpha band activity provides a measure that internal focus is increasing (theta) while relaxation is decreasing (alpha), which together suggest that the consumer is actively processing the stimulus (e.g., the advocacy material).

Autonomic nervous system measurement mechanisms that are employed in some examples disclosed herein include electrocardiograms (EKG) and pupillary dilation, etc. Effector measurement mechanisms that are employed in some examples disclosed herein include electrooculography (EOG), eye tracking, facial emotion encoding, reaction time, etc. Also, in some examples, the data collector(s) 110 collect other type(s) of central nervous system data, autonomic nervous system data, effector data and/or other neuro-response data. The example collected neuro-response data may be indicative of one or more of alertness, engagement, attention and/or resonance.

In the illustrated example, the data collector(s) 102 collects neurological and/or physiological data from multiple sources and/or modalities. In the illustrated, the data collector 102 includes components to gather EEG data 104 (e.g., scalp level electrodes), components to gather EOG data 106 (e.g., shielded electrodes), components to gather fMRI data 108 (e.g., a differential measurement system, components to gather EMG data 110 to measure facial muscular movement (e.g., shielded electrodes placed at specific locations on the face) and components to gather facial expression data 112 (e.g., a video analyzer). The data collector(s) 102 also may include one or more additional sensor(s) to gather data related to any other modality disclosed in herein including, for example, GSR data, MEG data, EKG data, pupillary dilation data, eye tracking data, facial emotion encoding data and/or reaction time data. Other example sensors include cameras, microphones, motion detectors, gyroscopes, temperature sensors, etc., which may be integrated with or coupled to the data collector(s) 102.

In some examples, only a single data collector 102 is used. In other examples a plurality of data collectors 102 are used. Data collection is performed automatically in the example of FIG. 1. In addition, in some examples, the data collected is digitally sampled and stored for later analysis such as, for example, in the database 114. In some examples, the data collected is analyzed in real-time. According to some examples, the digital sampling rates are adaptively chosen based on the type(s) of physiological, neurophysiological and/or neurological data being measured.

In the example system 100 of FIG. 1, the data collector(s) 110 are communicatively coupled to other components of the example system 100 via communication links 116. The communication links 116 may be any type of wired (e.g., a databus, a USB connection, etc.) or wireless communication mechanism (e.g., radio frequency, infrared, etc.) using any past, present or future communication protocol (e.g., Bluetooth, USB 2.0, etc.). Also, the components of the example system 100 may be integrated in one device or distributed over two or more devices.

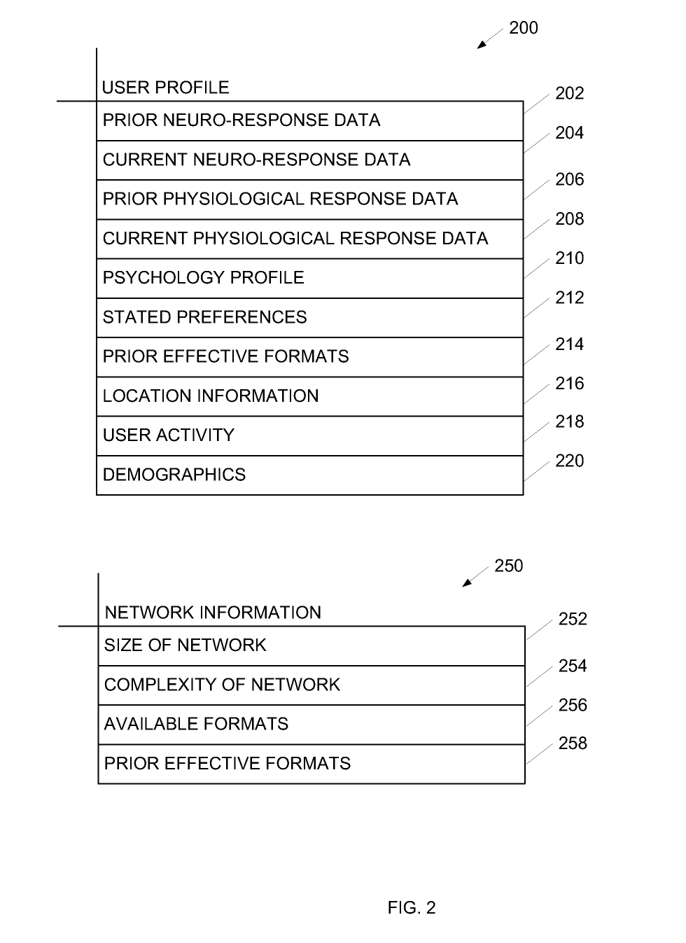

The example system 100 includes a profiler 118 that compiles a user profile for the user based on one or more characteristics of the user including, for example neuro-response data, age, income, gender, interests, activities, past purchases, skills, past coursework, academic profile, social network data (e.g., number of connections, frequency of use, etc.) and/or other data. An example user profile 200 is shown in FIG. 2. Some of the example characteristics that are used by the example profiler 118 of FIG. 1 include prior neuro-response data 202, current neuro-response data 204, prior physiological response data 206 and/or current physiological response data 208. The neuro-response data 202, 204 and the physiological response data 206, 208 may be data collected from any one or any combination of neurological and physiological measurements such as, for example, EEG data, EOG data, fMRI data, EMG data, facial expression data, GSR data, etc. The example profiler 118 also builds or compiles the user profile 200 using a psychological profile 210, which may include, for example data and/or an assessment of the five factor model (openness, conscientiousness, extraversion, agreeableness, and neuroticism). In the example of FIG. 2, a user's stated preferences 212 are incorporated into the user profile 200. Furthermore, in the example of FIG. 2, formats that were previously determined to be effective for a user 214, location information 216, and user activity 218 are stored in the example user profile 200. In addition, the example user profile 200 may include demographic data 220 such as, for example, the demographic data described above.

The example system 100 of FIG. 1 also includes a selector 120, which is communicatively coupled to a social network 122 of the user. The selector 120 of the illustrated example formats the presentation (e.g., the advertisement, entertainment, instructional materials, etc.) based on a current state of the user as determined from the neuro-response data, data in the user profile 200, and/or network information 250 (FIG. 2) associated with the social network 122. The network information 250 is stored in the user profile 200 or in a separate profile 250 and, in the illustrated example includes information related to the size of a user's network 252, the complexity of the user's network 254 (e.g., number of unrelated connections, geographic distribution of connections, number of interactions and interconnections between connections, etc.), type(s) of available format(s) for the network 256 (e.g., banners, pop-up windows, location, duration, size, brightness, color, font, etc.) and/or previously determined effective format(s) for the network 258 and/or user. For example, the user profile 200 may indicate that the user is a visual learner (e.g., as recorded, for example, in prior neuro-response data 202, stated preferences 212 and/or prior effective formats 214 of the example user profile 200), and, thus, the selector 120 formats the presentation to provide visual learning materials. In another example, a user profile 200 may indicate that video lectures are effective formats for that user (e.g., as recorded, for example, in prior neuro-response data 202, stated preferences 212 and/or prior effective formats 214 of the example user profile 200), and, thus, the selector 120 formats the presentation to provide video lectures. In another example, the network information 250 may indicate that the user is not very active on the social network (e.g., as recorded, for example, in the user activity 218 of the example user profile 200), and, thus, the selector 120 formats the presentation so that presentation content does not change frequently to increase the likelihood that the user sees the presentation content. In still another example, a user profile 200 may indicate that the user is responding positively to presentation content in a banner ad featuring particular members of the user's social network (e.g., as recorded, for example, in current neuro-response data 204, current physiological response data 208 and/or stated preference 212 of the example user profile 200). In such example, the selector 120 formats the presentation such that larger and/or additional banners are presented that feature more of the user's connections and/or the user's connections more frequently.

The example system 100 of FIG. 1 also includes an analyzer 124. The example analyzer 124 reviews neuro-response data and/or physiological response data obtained by the data collector 102 while or after the user is exposed to the presentation. The analyzer 124 of the illustrated example populates and/or adjusts the user profile 200 with the data it generates. The analyzer 124 of the illustrated example examines, for example, first neuro-response data that includes data representative of an interaction between a first frequency band of EEG activity of a brain of the user and a second frequency band of EEG data that is different than the first frequency band. Based on the evaluation of the neuro-response data and/or physiological response data, the analyzer 120 of the illustrated example determines if the presentation format is effective. In some examples, the analyzer 124 receives the data gathered from the data collector(s) 102 and analyzes the data for trends, patterns and/or relationships. The analyzer 124 of the illustrated example reviews data within a particular modality (e.g., EEG data) and between two or more modalities (e.g., EEG data and eye tracking data). Thus, the analyzer 124 of the illustrated example provides an assessment of intra-modality measurements and cross-modality measurements.

With respect to intra-modality measurement enhancements, in some examples, brain activity is measured to determine regions of activity and to determine interactions and/or types of interactions between various brain regions. Interactions between brain regions support orchestrated and organized behavior. Attention, emotion, memory, and other abilities are not based on one part of the brain but instead rely on network interactions between brain regions. Thus, measuring signals in different regions of the brain and timing patterns between such regions provide data from which attention, emotion, memory and/or other neurological states can be recognized. In addition, different frequency bands used for multi-regional communication may be indicative of a user's reaction(s) and/or impression(s) (e.g., a level of alertness, attentiveness and/or engagement). Thus, data collection using an individual collection modality such as, for example, EEG is enhanced by collecting data representing neural region communication pathways (e.g., between different brain regions). Such data may be used to draw reliable conclusions of a user's reaction(s) and/or impression(s) (e.g., engagement level, alertness level, etc.) and, thus, to provide the bases for determining if presentation format(s) were effective. For example, if a user's EEG data shows high theta band activity at the same time as high gamma band activity, both of which are indicative of memory activity, an estimation may be made that the user's reaction(s) and/or impression(s) is one of alertness, attentiveness and engagement.

With respect to cross-modality measurement enhancements, in some examples, multiple modalities to measure biometric, neurological and/or physiological data is used including, for example, EEG, GSR, EKG, pupillary dilation, EOG, eye tracking, facial emotion encoding, reaction time and/or other suitable biometric, neurological and/or physiological data. Thus, data collected using two or more data collection modalities may be combined and/or analyzed together to draw reliable conclusions on user states (e.g., engagement level, attention level, etc.). For example, activity in some modalities occurs in sequence, simultaneously and/or in some relation with activity in other modalities. Thus, information from one modality may be used to enhance or corroborate data from another modality. For example, an EEG response will often occur hundreds of milliseconds before a facial emotion measurement changes. Thus, a facial emotion encoding measurement may be used to enhance an EEG emotional engagement measure. Also, in some examples EOG and eye tracking are enhanced by measuring the presence of lambda waves (a neurophysiological index of saccade effectiveness) in the EEG data in the occipital and extra striate regions of the brain, triggered by the slope of saccade-onset to estimate the significance of the EOG and eye tracking measures. In some examples, specific EEG signatures of activity such as slow potential shifts and measures of coherence in time-frequency responses at the Frontal Eye Field (FEF) regions of the brain that preceded saccade-onset are measured to enhance the effectiveness of the saccadic activity data. Some such cross modality analyses employ a synthesis and/or analytical blending of central nervous system, autonomic nervous system and/or effector signatures. Data synthesis and/or analysis by mechanisms such as, for example, time and/or phase shifting, correlating and/or validating intra-modal determinations with data collection from other data collection modalities allow for the generation of a composite output characterizing the significance of various data responses and, thus, the classification of attributes of a property and/or representative based on a user's reaction(s) and/or impression(s).

According to some examples, actual expressed responses (e.g., survey data) and/or actions for one or more user(s) or group(s) of users may be integrated with biometric, neurological and/or physiological data and stored in the database 114 in connection with one or more presentation format(s). In some examples, the actual expressed responses may include, for example, a user's stated reaction and/or impression and/or demographic and/or preference information such as an age, a gender, an income level, a location, interests, buying preferences, hobbies and/or any other relevant information. The actual expressed responses may be combined with the neurological and/or physiological data to verify the accuracy of the neurological and/or physiological data, to adjust the neurological and/or physiological data and/or to determine the effectiveness of the presentation format(s). For example, a user may provide a survey response in which details why a purchase was made. The survey response can be used to validate neurological and/or physiological response data that indicated that the user was engaged and memory retention activity was high.

In some example(s), the selector 120 of the example system 100 selects a second, i.e., different presentation format when the analyzer 124 determines that the presentation format is not effective (e.g., the neuro-response data indicated that the user was disengaged and/or otherwise not attentive to the presentation content as formatted), different presentation format, including, for example, different content, arrangement, organization, and/or duration, may be presented to the user. Different presentation format may be obtained based on information in the user profile 200 and/or network information 250.

The example system 100 of FIG. 1 also includes a location detector 126 to determine a geographic location of the user. In some examples, the location detector 126 includes one or more sensor(s) are integrated with or otherwise communicatively coupled to a global positioning system and/or a wireless internet location service, which are used to determine the location of the user. Also, in some examples, cellular triangulation is used to determine the location. In other examples, the consumer is requested to manually indicate his or her location. In some examples, one or more sensor(s) are coupled with a mobile device such as, for example, a mobile telephone, an audience measurement device, an ear piece, and/or a headset with a plurality of electrodes such as, for example, dry surface electrodes. The sensor(s) of the location detector 126 may continually track the user's movements or may be activated at discrete locations and/or periodically or aperiodically. In some examples, the sensor(s) of the location detector 126 are integrated with the data collector(s) 102.

In some example(s), the selector 120 changes the presentation format based on a change in the location. For example, when the location detector 126 detects a user entering a grocery store, learning materials in the form of, for example, a wall post, banner ad and/or pop-up window regarding nutritional value of whole grain foods may be presented to the user. In another example, if the user is travelling and moves to a second location such as, for example, a location outdoors or closer to a highway or congested area, the selector 120 may change the presentation format such that an audio portion of the presentation is presented at an increased volume. In another example, if the location detector 126 indicates that the location is changing at a rate faster than a human can walk and along a major road such as, for example, a limited access highway, the system 100 may ascertain that the user is driving, and the selector 120 may format the presentation to either block all presentations, present only audio format, and/or present safety information or data related to traffic conditions.

While example manners of implementing the example system 100 to format a presentation have been illustrated in FIG. 1, one or more of the elements, processes and/or devices illustrated in FIG. 1 may be combined, divided, re-arranged, omitted, eliminated and/or implemented in any other way. Further, the example data collector(s) 102, the example database 114, the example profiler 118, the example selector 120, the example analyzer 124 and/or the example location detector 126 and/or, more generally, the example system 100 of FIG. 1 may be implemented by hardware, software, firmware and/or any combination of hardware, software and/or firmware. Thus, for example, the example data collector(s) 102, the example database 114, the example profiler 118, the example selector 120, the example analyzer 124 and/or the example location detector 126 and/or, more generally, the example system 100 of FIG. 1 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example data collector(s) 102, the example database 114, the example profiler 118, the example selector 120, the example analyzer 124 and/or the example location detector 126 are hereby expressly defined to include a tangible computer readable medium such as a memory, DVD, CD, etc. storing the software and/or firmware. Further still, the example system 100 of FIG. 1 may include one or more elements, processes and/or devices in addition to, or instead of, those illustrated in FIG. 1, and/or may include more than one of any or all of the illustrated elements, processes and devices.

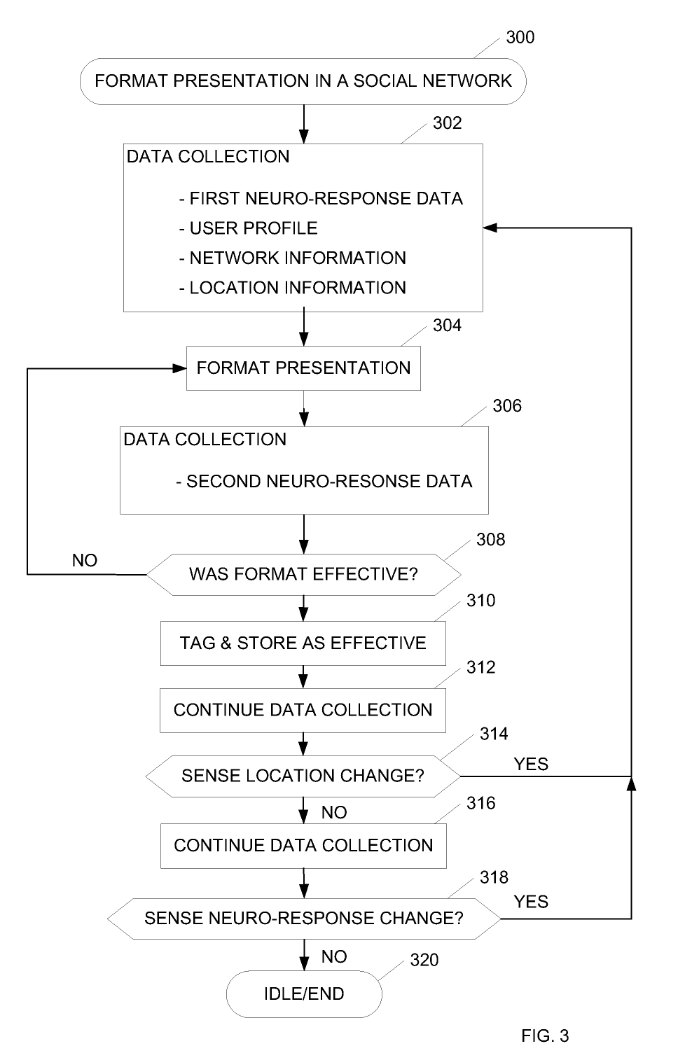

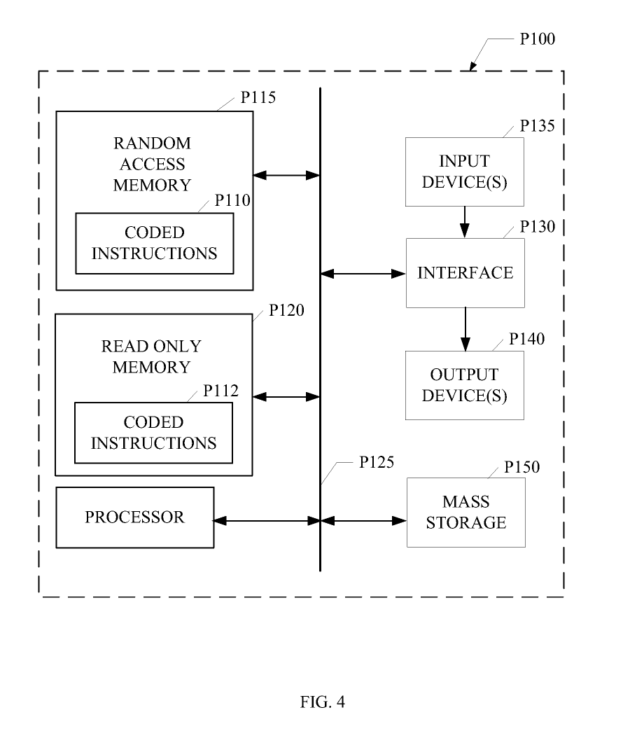

FIG. 3 is a flowchart representative of example machine readable instructions that may be executed to implement the example system 100, the example data collector(s) 102, the example database 114, the example profiler 118, the example selector 120, the example analyzer 124 and/or the example location detector 126 and other components of FIG. 1. In the examples of FIG. 3, the machine readable instructions include a program for execution by a processor such as the processor P105 shown in the example computer P100 discussed below in connection with FIG. 4. The program may be embodied in software stored on a tangible computer readable medium such as a CD-ROM, a floppy disk, a hard drive, a digital versatile disk (DVD), or a memory associated with the processor P105, but the entire program and/or parts thereof could alternatively be executed by a device other than the processor P105 and/or embodied in firmware or dedicated hardware. Further, although the example program is disclosed with reference to the flowchart illustrated in FIG. 3, many other methods of implementing the example system 100, the example data collector(s) 102, the example database 114, the example profiler 118, the example selector 120, the example analyzer 124 and/or the example location detector 126 and other components of FIG. 1 may alternatively be used. For example, the order of execution of the blocks may be changed, and/or some of the blocks disclosed may be changed, eliminated, or combined.

As mentioned above, the example processes of FIG. 3 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIG. 3 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

FIG. 3 illustrates an example process to format a presentation. The example process 300 includes collecting data (block 302). Example data that is collected includes first neuro-response data from a user exposed to a presentation, user profile information including, for example, information provided in the example user profile 200 of FIG. 2, network information including, for example, the example network information 250 of FIG. 2 and/or location information such as, for example, the location of a user as detected by the example location detector 126 of FIG. 1.

The example method 300 of FIG. 3 formats (e.g., selects and/or adjusts) the presentation (block 304) based on the collected data. Further data is collected (block 306) including, for example neuro-response data and/or physiological response data. The additional data is collected while or shortly after the user is exposed to the presentation in the selected format. The additional data is analyzed (for example, with the data analyzer 124 of FIG. 1) to determine if the presentation and/or its format was effective (block 308). If the presentation and/or its format were not effective, additional/alternative presentation(s) and/or format(s) are selected (block 304). If the presentation and/or its format are determined to be effective (block 308), the presentation and/or its format may be tagged as effective (block 310) and stored, for example in the example database 114 of FIG. 1 as a previously identified known effective format. Data collection continues (block 312) while the user and network are monitored.

The example method 300 of FIG. 3 also determines if the user has changed locations (block 314). For example, the example location detector 126 of FIG. 1 may track the user's position and detect changes in location. If the user has changed locations, the second location is detected (block 302), and the example method 300 continues to format a presentation (block 304) for presentation to the user. If the user has not changed location (block 314), the example method 300 continues collecting data (block 316).

If a change in a user's neuro-response data is detected (block 318) such as, for example, the user is no longer paying attention to a presentation (as detected, for example via the data collector 102 and the analyzer 124 of FIG. 1), control returns to block 302 where additional data is collected including, for example, additional neuro-response data, other user profile data, etc. If a change in a user's neuro-response data is not detected (block 318), the example method 300 may end or sit idle until a future change is detected.

FIG. 4 is a block diagram of an example processing platform P100 capable of executing the instructions of FIG. 3 to implement the example system 100, the example data collector(s) 102, the example database 114, the example profiler 118, the example selector 120, the example analyzer 124 and/or the example location detector 126. The processor platform P100 can be, for example, a server, a personal computer, or any other type of computing device.

The processor platform P100 of the instant example includes a processor P105. For example, the processor P105 can be implemented by one or more Intel® microprocessors. Of course, other processors from other families are also appropriate.

The processor P105 is in communication with a main memory including a volatile memory P115 and a non-volatile memory P120 via a bus P125. The volatile memory P115 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory P120 may be implemented by flash memory and/or any other desired type of memory device. Access to the main memory P115, P120 is typically controlled by a memory controller.

The processor platform P100 also includes an interface circuit P130. The interface circuit P130 may be implemented by any type of past, present or future interface standard, such as an Ethernet interface, a universal serial bus (USB), and/or a PCI express interface.

One or more input devices P135 are connected to the interface circuit P130. The input device(s) P135 permit a user to enter data and commands into the processor P105. The input device(s) can be implemented by, for example, a keyboard, a mouse, a touchscreen, a track-pad, a trackball, isopoint and/or a voice recognition system.

One or more output devices P140 are also connected to the interface circuit P130. The output devices P140 can be implemented, for example, by display devices (e.g., a liquid crystal display, and/or a cathode ray tube display (CRT)). The interface circuit P130, thus, typically includes a graphics driver card.

The interface circuit P130 also includes a communication device, such as a modem or network interface card to facilitate exchange of data with external computers via a network (e.g., an Ethernet connection, a digital subscriber line (DSL), a telephone line, coaxial cable, a cellular telephone system, etc.).

The processor platform P100 also includes one or more mass storage devices P150 for storing software and data. Examples of such mass storage devices P150 include floppy disk drives, hard drive disks, compact disk drives and digital versatile disk (DVD) drives.

The coded instructions of FIG. 3 may be stored in the mass storage device P150, in the volatile memory P110, in the non-volatile memory P112, and/or on a removable storage medium such as a CD or DVD.

Although certain example methods, apparatus and properties of manufacture have been disclosed herein, the scope of coverage of this patent is not limited thereto. On the contrary, this patent covers all methods, apparatus and properties of manufacture fairly falling within the scope of the claims of this patent.

What is claimed is:

1. A method of formatting a presentation, the method comprising:
collecting first neuro-response data from the user while the user is engaged with a social network; and
formatting the presentation based on the first neuro-response data and social network information identifying a characteristic of the social network of the user.

2. A method of claim 1 wherein formatting the presentation comprising formatting the presentation based on a known effective formatting parameter corresponding to at least one of the first neuro-response data or the social network information.

3. A method of claim 1 further comprising:
collecting second neuro-response data at least one of while or after the user is exposed to the presentation;
determining an effectiveness of the presentation based on the second neuro-response data; and
re-formatting the presentation based on the second neuro-response data if the presentation is not effective.

4. A method of claim 1 wherein formatting the presentation is further based on user activity.

5. A method of claim 4 wherein the user activity comprises at least one of the user's comments posted on the social network, the user's interactions with connections in the social network, or an attention level.

6. A method of claim 1 wherein formatting the presentation is based on a location of user.

7. A method of claim 1 wherein the presentation comprises at least one of a learning material, an advertisement or entertainment.

8. A method of claim 1 wherein the presentation is presented in at least one of a game, a webpage banner, a pop-up display, a newsfeed, a chat message, or an intermediate display while a content is loading.

9. A method of claim 1 wherein the first neuro-response data includes data representative of an interaction between a first frequency band of activity of a brain of the user and a second frequency band different than the first frequency band.

10. A method of claim 1 wherein formatting the presentation comprises determining at least one of a presentation type, a length of presentation, an amount of content presented in a session, a presentation medium, or an amount of content presented simultaneously.

11. A method of claim 1 wherein the social network information comprises at least one of a number of connections of the user in the social network or a complexity of the connections.

12. A system to format a presentation, the system comprising:
a data collector to collect first neuro-response data from a user while the user is engaged with a social network;
a profiler to compile a user profile for a user based on the first neuro-response data; and
a selector to format the presentation based on the user profile and information about a characteristic of the social network.

13. A system of claim 12, wherein the selector is to format the presentation based on a known effective formatting parameter.

14. A system of claim 12, wherein the data collector is to collect second neuro-response data from the user at least one of while or after the user is exposed to the presentation, the profiler to compile the user profile based on the second neuro-response data, the system further comprising an analyzer to determine an effectiveness of the presentation based on the second neuro-response data, the selector to re-format the presentation based on the second neuro-response data if the analyzer determines the presentation not to be effective.

15. A system of claim 12, wherein the selector is to format the presentation based on user activity, wherein the user activity comprises at least one of the user's comments posted on the social network, the user's interactions with connections in the social network, or an attention level.

16. A system of claim 12 further comprising a location detector to determine a location of the user, the selector to format the presentation based on the location.

17. A system of claim 12, wherein the first neuro-response data includes data representative of an interaction between a first frequency band of activity of a brain of the user and a second frequency band different than the first frequency band.

18. A system of claim 12, wherein the selector is to determine at least one of a presentation type, a length of presentation, an amount of content presented in a session, a presentation medium, or an amount of content presented simultaneously.

19. A tangible machine readable medium storing instructions thereon which, when executed, cause a machine to at least:
collect first neuro-response data from the user while the user is engaged with a social network; and
format the presentation based on the first neuro-response data and social network information identifying a characteristic of the social network of the user.

20. The machine readable medium of claim 19 further causing the machine to:
collect second neuro-response data from the user at least one of while or after the user is exposed to the presentation;
determine an effectiveness of the presentation based on the second neuro-response data; and
re-format the presentation based on the second neuro-response data if the presentation is not effective.
